(19) United States
(12) Patent Application Publication
(10) Pub. No.: US 2026/0021638 A1
(43) Pub. Date: Jan. 22, 2026

(54) APPARATUS, SYSTEM, AND METHOD FOR AUTOMATED DEPOWDERING AND EXTRACTION OF THREE-DIMENSIONAL PRINTED PARTS

(71) Applicant: DEI HOLDING LTD, Yosef (IL)

(72) Inventor: Avner DEI, Carmen Yosef (IL)

(21) Appl. No.: 18/995,931

(22) PCT Filed: Aug. 18, 2023
(86) PCT No.: PCT/IB2023/058264

§ 371 Date: Jan. 17, 2025

Related U.S. Application Data
(60) Provisional application No. 63/398,861, filed on Aug. 18, 2022.

(51) Int. Cl. B29C 64/379; B22F 10/14; B22F 12/00; B22F 12/60; B22F 12/88; B22F 12/90; B28B 1/00; B28B 11/22; B29C 64/165; B29C 64/232; B33Y 30/00; B33Y 40/00

(52) U.S. Cl. CPC B29C 64/379; B22F 10/14; B22F 12/222; B22F 12/60; B22F 12/88; B22F 12/90; B28B 1/001; B28B 11/22; B29C 64/165; B29C 64/232; B33Y 30/00; B33Y 40/00

(57) ABSTRACT

Embodiments of the present disclosure provide an apparatus, a system, and a method. The apparatus is configured to depowder and extract one or more printed parts prepared by a three-dimensional (3D) printer. The apparatus includes an elevated frame, a perforated plate, a lifting-lowering mechanism, a depowdering unit, and at least one gripper. The elevated frame is removably secured to an open top of a first container and configured to transversely receive fully raised at least one 3D printed layer and partially raised at least one powder layer. Upon lifting the elevated frame along with the perforated plate, the depowdering unit is configured to depowder the at least one powder layer and powder in between the one or more 3D printed parts. The at least one gripper is configured to automatically extract the one or more 3D printed parts.

### TECHNICAL FIELD

The present disclosure relates to three-dimensional (3D) printing and, more particularly, relates, to an apparatus, system, and method for automated depowdering and extraction of 3D printed parts.

### BACKGROUND

Three-dimensional (3D) printing, known as ‘additive manufacturing,’ represents a prominent manufacturing method for producing precise parts, including intricate machine components. Specifically, the 3D printing manufacturing technique is known for fabricating complex parts efficiently and minimizing material waste. Moreover, 3D printing allows for the individual fabrication of parts in customizable batches or even at a mass production scale.

The 3D printing manufacturing process includes several distinct stages, namely preprocessing, processing, and post-processing of parts. The preprocessing step entails the creation of a Computer-Aided Design (CAD) model of desired parts in a computer, followed by importing the CAD model into the 3D printer in machine-readable form. The processing steps involve one or more sub-steps such as (a) storing the powder in a storage box of the 3D printer, (b) transferring a small quantity of powder to the printing box within the 3D printer, followed by the flattening of this powder by the printing device (c) processing that includes heating and hardening the flattened layer. These sequential steps are repeated until the desired parts are fabricated. Further, the post-processing step includes additional steps such as extracting 3D printed parts while depowdering the remaining powder (removing excess powder), cleaning the printing box, etc. The post-processing step also includes the sintering step, where the parts are placed into the furnace to get the desired share of the parts.

FIG. 1 illustrates a simplified block diagram of a system 100 related to a 3D printing process. The system 100 primarily includes a three-dimensional (3D) printer 102, and a controller 106 electronically connected to the 3D printer 102. The 3D printer 102 is designed to fabricate 3D-printed parts. The 3D printer 102 includes at least a print box 108 and a linear drive actuator 110. The print box 108 can be mounted to the linear drive actuator 110. The controller 106 operates the linear drive actuator 110, such that the 3D-printed parts are fabricated in the print box 108. The detailed printing process of the 3D printer 102 is explained in FIGS. 2A-2D. The controller 106 may take the form of a microprocessor or similar programmable devices.

FIGS. 2A-2D illustrate frontal views of an example representation of the conventional system 100, the highlighting operations involved in fabricating one or more 3D printed parts 201 (as shown in FIG. 2D). The 3D printer 102 can be a Selective Laser Sintering (SLS) 3D printer. However, it should be understood that different types of 3D printers including, but not limited to, Binder Jet Pinting (BJP), Direct Metal Laser Sintering (DMLS), Fused Deposition Modeling (FDM), Digital Light Process (DLP), Multi-Jet Fusion (MJF), Electronic Beam Melting (EBM), and similar technologies may also be incorporated. It is also important to note that the selection of the SLS 3D printer (e.g., the 3D printer 102) in this disclosure serves as an example, and the system 100 may be implemented with any other aforementioned 3D printer 102 that utilizes the print box 108.

The 3D printer 102 includes the print box 108, a storage container 202, the linear drive actuator 110, and another linear drive actuator 204 (also referred to as linear drive actuator 204). The storage container 202 is designed for the containment of powder 205 and incorporates a movable tray 206 and an open head 208. The powder 205 stored within the storage container 202 is initially transported to the print box 108 and subsequently subjected to processing, which involves heating and hardening the powders, utilizing a binder jetting device 210 integrated within the 3D printer 102. The nature of the powder 205 utilized herein can encompass both metallic and non-metallic materials, depending on the specific material requirements for the fabrication of the one or more 3D printed parts 201. Examples of such materials include but are not limited to, Stainless Steel (SS) of grades three hundred sixteen and four hundred twenty, silicon carbide, aluminum, copper, various plastics, polymers, sand, and similar substances. Correspondingly, a suitable binder material may be selected for the production of the one or more 3D printed parts 201 (Refer to FIG. 2D).

When the powder 205 is filled in the storage container 202, the movable tray 206 is at a Bottom Dead Center (BDC) of the storage container 202. In case, the storage container 202 is empty with no powder in it, the movable tray 206 is at a Top Dead Center (TDC). In between BDC and TDC, the movable tray 206 reciprocates in a downward and upward direction 212 by distance H (see, FIG. 2A). The movable tray 206 is operated by the linear drive actuator 204. The linear drive actuator 204 is electronically connected to the controller 106 (shown in FIG. 1) and reciprocally coupled to the movable tray 206 to raise a part of the powder 205 above the open head 208 by a predetermined height (e.g. ΔH) of the height H (see, FIG. 2B). The predetermined height ΔH provided by the linear drive actuator 204 is controlled by the controller 106. When the movable tray 206 reciprocates transversely in the upward direction 212 by the third predefined height ΔH, the powder 205 stored in the storage container 202 will also reciprocate in the upward direction 212 by the predefined height ΔH above the open head 208.

The linear drive actuator 204 may take the form of a hydraulic linear actuator, a pneumatic linear actuator, an electric linear actuator, or a piezoelectric actuator. The linear drive actuator 204 shown in the illustrated example is the hydraulic linear actuator. This hydraulic linear actuator is designed to transform the energy stored within the working fluid into mechanical work, primarily facilitating the reciprocating motion of the movable tray 206. The working fluid's pressure acts upon a piston within the hydraulic linear actuator, generating a propulsive force that induces the upward reciprocating movement of the movable tray 206 along the vertical direction 212. As the linear drive actuator 204 maintains an electronic connection with the controller 106, adjustments to the predetermined height ΔH can be made as necessary.

A pusher device 214 within the 3D printer 102 is electrically connected to the controller 106 and designed to transfer the portion of the powder 205 corresponding to the predetermined height ΔH (i.e., the powder situated above the open head 208) to the open top 216 of the print box 108. This pusher device 214 incorporates a powder spreader 218. The powder spreader 218 is configured to level the powder positioned at the open top 216, resulting in the formation of a sublayer 220 (as depicted in FIG. 2C). The powder spreader 218 takes the shape of a square plate, which is reciprocated by a movable bar 221 within the pusher device 214. However, in an alternative configuration, a cylindrical powder spreader may be utilized.

Referring now to FIG. 2D, the print box 108 is designed to accommodate a plurality of extraction layers 224 longitudinally, extending from the movable base 222 to the open top 216. The plurality of extraction layers 224 includes at least one 3D printed layer 228 (also referred to as “3D printed layer 228”) and at least one powder layer 230 (also referred to as “powder layer 230”). These layers, namely the 3D printed layer 228 and the powder layer 230, are alternatively arranged. The 3D printed layer 228 consists of one or more 3D printed parts 201, with powder 232 interspersed among the one or more 3D printed parts 201. In the illustrated example, the one or more 3D printed parts 201 have cuboidal shapes. However, in other examples, more intricate and non-symmetrical shapes can also be prepared.

During the initiation of the printing process, the movable base 222 is at a Top Dead Center (TDC) of the print box 108 (i.e., at the open top 216). As the print box 108 becomes filled with the plurality of extraction layers 224, the movable base 222 commences a downward reciprocating motion 234 by a distance denoted as Y (refer to FIG. 2D) until it reaches the Bottom Dead Center (BDC) of the print box 108.

The movable base 222 is actuated by the linear drive actuator 110. The linear drive actuator 110 is electronically connected to the controller 106 and reciprocally coupled to the movable base 222 to elevate the 3D printed layer 228 located at the uppermost part of the plurality of extraction layers 224, raising it to a predetermined height AY of the height Y (shown in FIG. 3B) from the open top 216. Additionally, the linear drive actuator 110 partially raises the powder layer 230 disposed beneath the fully raised 3D printed layer 228.

The linear drive actuator 110 may take the form of a hydraulic linear actuator, a pneumatic linear actuator, an electric linear actuator, or a piezoelectric actuator. In the illustrated example, the linear drive actuator 110 is specifically represented as a hydraulic linear actuator. The hydraulic linear actuator is configured to convert the energy stored within the working fluid contained within the hydraulic linear actuator into mechanical work, thereby facilitating the reciprocating motion of the movable base 222. The pressure of the working fluid acts on a piston of the hydraulic linear actuator, generating a pushing force that induces the upward reciprocating movement of the movable base 222 along the upward direction 212. As the linear drive actuator 110 is electronically connected to the controller 106, the predetermined height ΔY can be adjusted as necessary.

In the post-processing of 3D printed parts especially where the printed objects are fragile and in mass production involving the printing of a large number of parts, the process of depowdering and extraction of the parts from a printing box of the 3D printer is tedious and requires extensive human effort. Usually, the depowering and extracting of the printed parts are done manually using skilled human workers. The skilled human workers slowly remove the powder between the printed parts and take out the parts carefully, one by one from the printed surface placed in the printing box of the 3D printer. However, while taking out the printed parts, accessing each level becomes more difficult as the skilled human workers need to go deeper into the print box.

Therefore, there exists a need to develop a system that automates one or more post-processing steps and overcomes one or more limitations stated above in addition to providing other technical advantages.

### SUMMARY

Various embodiments of the present disclosure provide an apparatus, a system, and a method for automated depowdering and extracting three-dimensional (3D) printed parts.

In an embodiment, a system for automated depowdering and extracting three-dimensional (3D) printed parts is disclosed. The system includes a controller, a first container, a first linear drive actuator, and an apparatus. The first container has a movable base and an open top. The first container is configured to longitudinally accommodate a plurality of extraction layers. The plurality of extraction layers includes at least one 3D printed layer and at least one powder layer. The at least one powder layer is alternatively arranged with the least one 3D printed layer. The at least one 3D printed layer includes one or more 3D printed parts and powder in between the one or more 3D printed parts. The first linear drive actuator is electronically connected to the controller and reciprocally coupled to the movable base to fully raise the at least one 3D printed layer located at a top of the plurality of extraction layers up to a first predefined height from the open top and to partially raise the at least one powder layer disposed below the fully raised at least one 3D printed layer. The apparatus is electronically connected to the controller and configured to depowder the at least one powder layer and the powder in between one or more 3D printed parts and to extract the one or more 3D printed parts. The apparatus includes an elevated frame, a perforated plate, a lifting-lowering mechanism, a depowdering unit, and at least one gripper. The elevated frame is removably secured to the open top and configured to transversely receive the fully raised at least one 3D printed layer and the partially raised at least one powder layer. The perforated plate is slidably inserted into the elevated frame and longitudinally passed through the partially raised at least one powder layer. The perforated plate is configured to depowder at least a part of the partially raised at least one powder layer. The lifting-lowering mechanism is mechanically coupled to the elevated frame. The lifting-lowering mechanism is configured to removably secure the elevated frame to the open top during the slidably insertion of the performed plate into the elevated frame and to lift the elevated frame along with the perforated plate up to a second predefined height upon completion of the slidably insertion of the performed plate into the elevated frame. The depowdering unit is electronically coupled to the controller and configured to depowder the at least one powder layer, the powder in between one or more 3D printed parts, and the powder adhered to the one or more 3D printed parts. The at least one gripper is electronically coupled to the controller and configured to automatically extract the one or more 3D printed parts of the fully raised at least one 3D printed layer. The depowdering unit has a vibration shaker electronically connected to the controller and configured to impart vibratory motion to at least the perforated plate to depowder a part of the partially raised at least one powder layer and a part of the powder in between one or more 3D printed parts. The depowdering unit also has at least one pressure generator electronically coupled to the controller and configured to depowder the powder adhered to the one or more 3D printed parts.

In another embodiment, an apparatus for automated depowdering and extracting of three-dimensional (3D) printed parts is disclosed. The apparatus is mounted to a first container of a system and is electronically connected to a controller. The apparatus includes an elevated frame, a perforated plate, a lifting-lowering mechanism, a depowdering unit, and at least one gripper. The elevated frame is removably secured to the open top and configured to transversely receive the fully raised at least one 3D printed layer and the partially raised at least one powder layer. The perforated plate is slidably inserted into the elevated frame and is capable of longitudinally passing through the partially raised at least one powder layer. The perforated plate is configured to depowder at least a part of the partially raised at least one powder layer. The lifting-lowering mechanism is mechanically coupled to the elevated frame. The lifting-lowering mechanism is configured to removably secure the elevated frame to the open top during the slidably insertion of the performed plate into the elevated frame and to lift the elevated frame along with the perforated plate up to a second predefined height upon completion of the slidably insertion of the performed plate into the elevated frame. The depowdering unit is electronically coupled to the controller and configured to depowder the at least one powder layer, the powder in between one or more 3D printed parts, and the powder adhered to the one or more 3D printed parts. The at least one gripper is electronically coupled to the controller and configured to automatically extract the one or more 3D printed parts of the fully raised at least one 3D printed layer.

In yet another embodiment, a method for automatic depowdering and extracting three-dimensional (3D) printed parts is disclosed. The method includes accommodating a plurality of extraction layers in a first container. The plurality of extraction layers in a first container includes at least one 3D printed layer and at least one powder layer alternatively arranged with the least one 3D printed layer. The at least one 3D printed layer includes one or more 3D printed parts and powder in between one or more 3D printed parts. Next, the method includes raising fully the at least one 3D printed layer located at a top of the plurality of extraction layers to a first predefined height from the open top and partially the at least one powder layer disposed below the fully raised at least one 3D printed layer by a first linear drive actuator. Further, the method includes receiving the fully raised at least one 3D printed layer and the partially raised at least one powder layer transversely by an elevated frame of an apparatus. The elevated frame is removably secured to the open top. Next, the method includes receiving a perforated plate slidably by the elevated frame, and longitudinally passing through the partially raised at least one powder layer. The perforated plate is configured to depowder at least a part of the partially raised at least one powder layer. The method further includes lifting the elevated frame along with the perforated plate by a lifting-lowering mechanism of the apparatus, up to a second predefined height upon completion of the slidably insertion of the performed plate into the elevated frame. The method further includes depowdering the at least one powder layer, the powder in between one or more 3D printed parts, and the powder adhered to the one or more 3D printed parts by a depowdering unit of the apparatus. Next, the method includes extracting the one or more 3D printed parts of the fully raised at least one 3D printed layer by at least one gripper of the apparatus. In this method, the process of depowdering and extracting three-dimensional (3D) printed parts is repeated until all the 3D printed parts are extracted from the plurality of extraction layers. It should be noted that the extraction of the 3D printed parts is performed layer by layer of the plurality of extraction layers.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale.

FIG. 1 illustrates a simplified block diagram of a conventional system related to printing, depowdering, and extracting three-dimensional (3D) printed parts;

FIGS. 2A-2D illustrate an example representation of the conventional system showing operations involved in fabricating one or more 3D printed parts;

FIG. 3A illustrates a simplified block diagram of a system related to depowdering, and extracting three-dimensional (3D) printed parts, in accordance with one embodiment of the present disclosure;

FIG. 3B illustrates a perspective view of the system for depowdering and extracting one or more 3D printed parts, in accordance with one embodiment of the present disclosure;

FIG. 3C illustrates a front view of the system of FIG. 3B, in accordance with one embodiment of the present disclosure;

FIG. 4A illustrates a front view of the system of FIG. 3B showing an apparatus lifted from a first container, in accordance with one embodiment of the present disclosure;

FIG. 4B illustrates a perspective view of the system showing the apparatus lifted from the first container and a perforated plate partially inserted into an elevated frame, in accordance with one embodiment of the present disclosure;

FIG. 5A illustrates an example representation of a perspective view of a system, in accordance with another embodiment of the present disclosure;

FIG. 5B illustrates an example representation of an exploded view of the system of FIG. 5A, in accordance with another embodiment of the present disclosure;

FIG. 6 illustrates a perspective view of a system related to printing, depowdering, and extracting three-dimensional (3D) printed parts, in accordance with an alternate embodiment of the present disclosure; and

FIG. 7 illustrates a flow diagram illustrating a method for automated depowdering and extracting 3D printed parts, in accordance with an embodiment of the present disclosure.

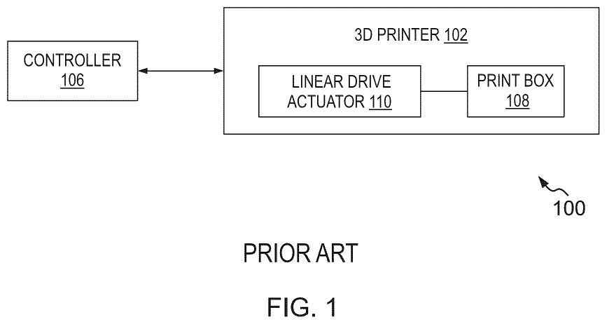

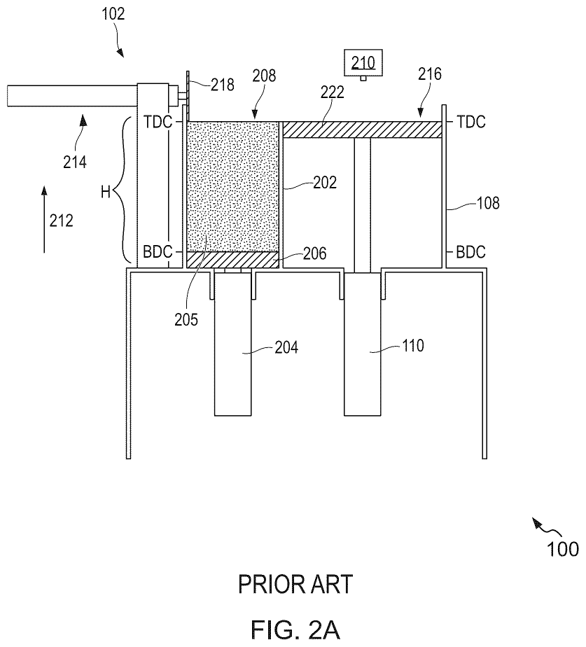

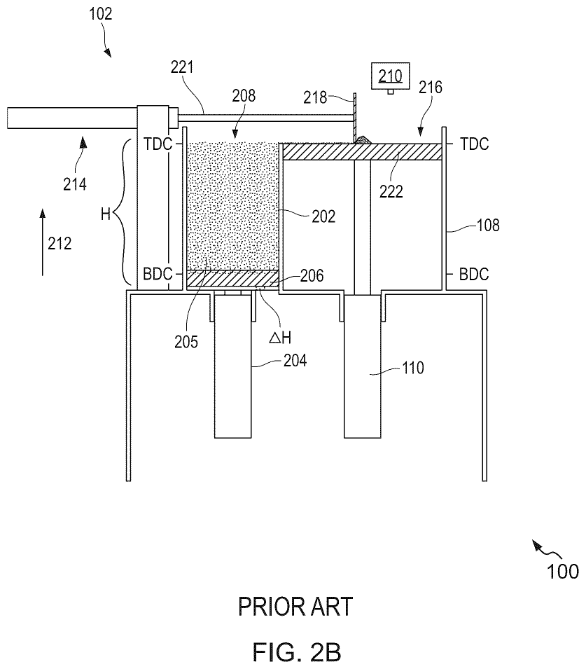

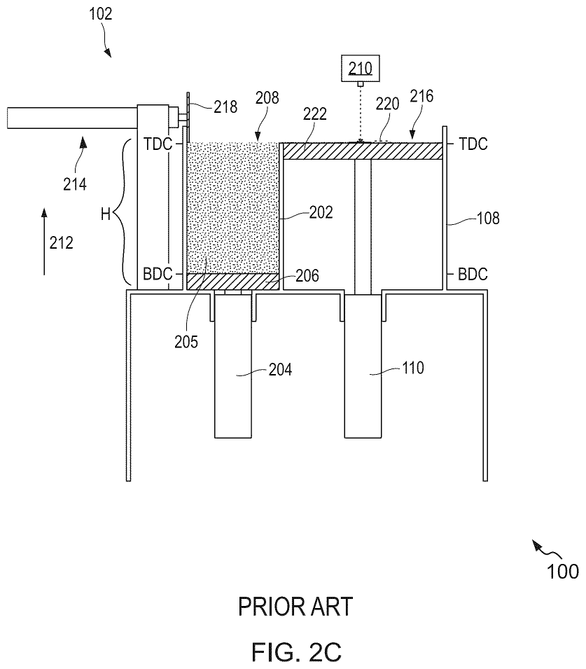

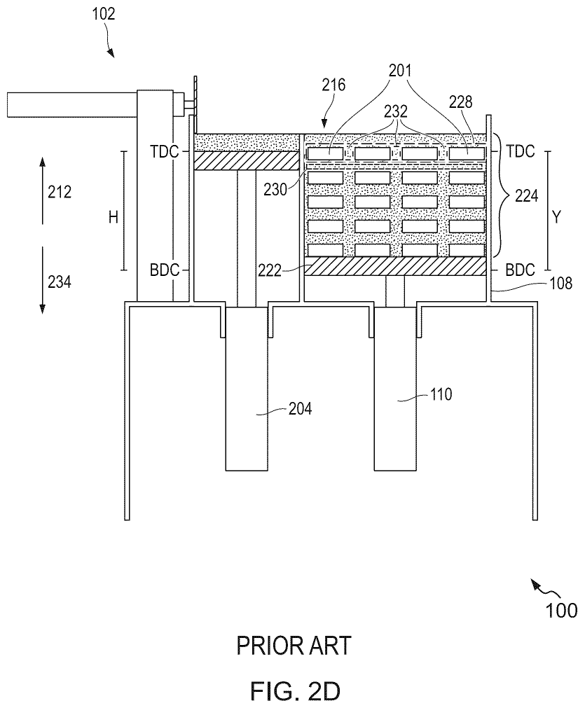

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### OVERVIEW

The present disclosure encompasses several embodiments of a system and a method designed to provide automatic depowdering and extracting of three-dimensional (3D) printed parts. In one embodiment of the present disclosure, a system includes a first container, a first linear drive actuator, an apparatus removably secured to the first container, and a controller electronically connected to the first linear drive actuator and the apparatus.

In an embodiment of the disclosure, a system for automated depowdering and extracting the one or more 3D printed parts includes the apparatus, the first container, a controller, and a first linear drive actuator. The first container is temporarily mounted to the first linear drive actuator. In this embodiment, the first container of the 3D printer (after printing the 3D parts in the first container using the 3D printer) can be temporarily mounted to the first linear drive actuator for depowdering and extracting the one or more 3D printed parts. The system is covered by a housing of a lifting-lowering mechanism. The first container accommodating the plurality of extraction layers can be temporarily mounted for depowdering and extracting purposes. Once the depowdering and extracting purposes are completed, the new container accommodating the plurality of extraction layers can be mounted for depowdering and extracting purposes.

The apparatus includes an elevated frame removably secured to an open top of the first container and configured to transversely receive a fully raised 3D printed layer and partially raised a powder layer of a plurality of extraction layers through a first linear drive actuator. A perforated plate of the apparatus is slidably inserted into the elevated frame which longitudinally passes through the partially raised powder layer. Perforated plate depowders at least a part of the partially raised powder layer. Further, a depowdering unit of the apparatus including a vibration shaker and a pressure generator depowder the powder of the fully raised 3D printed layer and the partially raised powder layer. Afterward, a gripper of the apparatus automatically extracts the one or more 3D printed parts of the fully raised 3D printed layer. The depowdered substance of the partially raised powder layer and the powder in between one or more 3D printed parts, collected in a channel of the elevated frame, are taken out by a suction mechanism and can be reused for printing purposes.

The depowdering unit has a vibration shaker electronically connected to the controller and configured to impart vibratory motion to at least the perforated plate to depowder a part of the partially raised at least one powder layer and a part of the powder in between one or more 3D printed parts. The depowdering unit also has at least one pressure generator electronically coupled to the controller and configured to depowder the powder adhered to the one or more 3D printed parts.

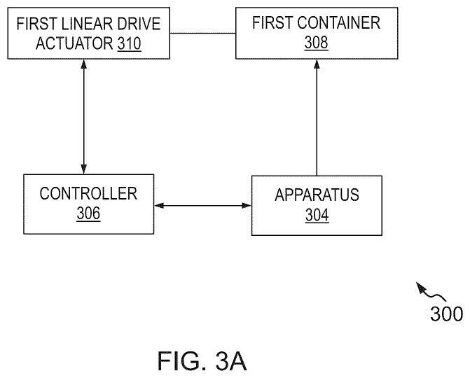

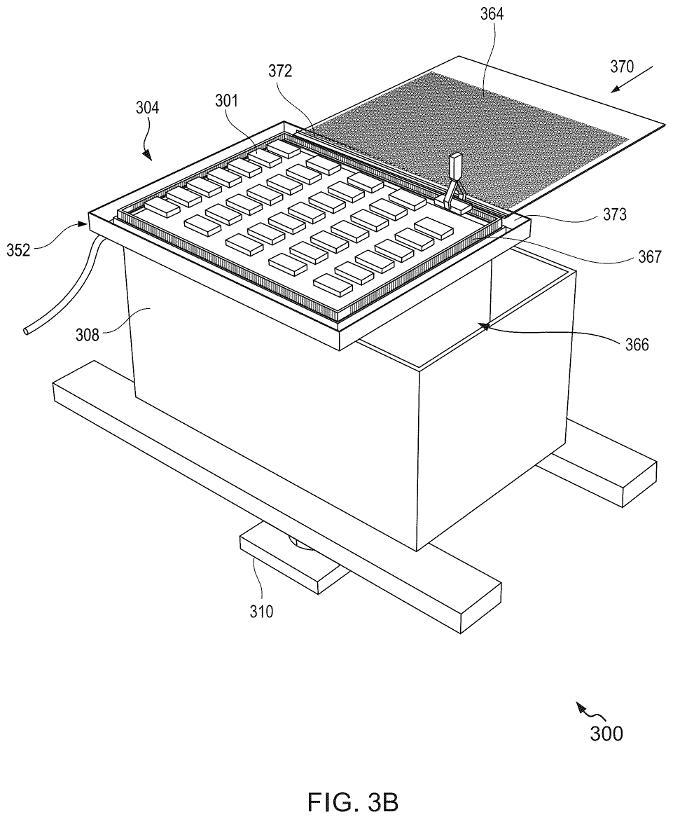

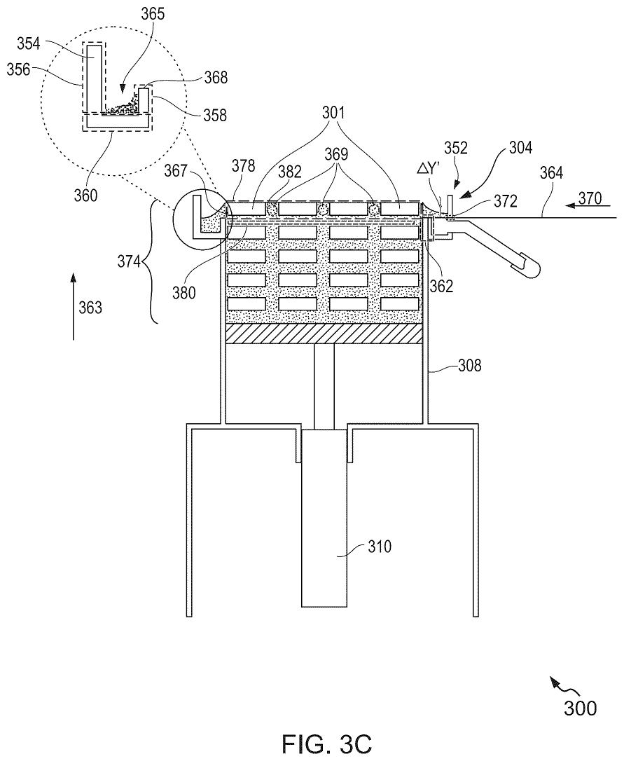

Various example embodiments of the present disclosure are described hereinafter with reference to FIG. 3A to FIG. 7.

FIG. 3A illustrates a simplified block diagram of a system 300 related to at least some embodiment of the present disclosure. The system 300 primarily includes a first container 308, a first linear drive actuator 310, an apparatus 304 removably secured to the first container 308, and a controller 306 electronically connected to both the first linear drive actuator 310 and the apparatus 304. The apparatus 304 is designed to depowder (hereinafter “depowder” is alternatively referred to as “remove”) and extract the one or more 3D printed parts fabricated using a 3D printer. The first container 308 can be temporarily mounted to the first linear drive actuator 310. Once the apparatus 304 completes the depowdering and extraction of the 3D printed parts from the first container 308, the first container 308 can be detached from the system 300 and a new container with one or more fabricated 3D printed parts can be installed on the first linear drive actuator 310 for performing depowdering and extraction operations.

The apparatus 304 (also referred to as depowdering and extracting 304) is configured in a manner that automates the operations related to depowdering and extracting the one or more 3D printed parts. The apparatus 304 is controlled by the controller 306 through electronic signals derived from input signals received from various components of the system 300. The controller 306 may take the form of a microprocessor or similar programmable devices. For example, the controller 306 may be embodied as one or more types of processing devices, such as a coprocessor, a microprocessor, a controller, a Digital Signal Processor (DSP), processing circuitry with or without an accompanying DSP, or various other processing devices, including integrated circuits like an Application Specific Integrated Circuit (ASIC), a Field Programmable Gate Array (FPGA), a Microcontroller Unit (MCU), a hardware accelerator, a special-purpose computer chip, integrated circuits, or similar components.

FIG. 3B illustrates a perspective view of the system 300 for depowdering and extracting one or more 3D printed parts, in accordance with one embodiment of the present disclosure. Additionally, FIG. 3C presents a front view of the system 300 depicted in FIG. 3B, in accordance with the same embodiment of the present disclosure. The apparatus 304 includes an elevated frame 352. The elevated frame 352 is designed to be securely attached to the open top 366 and is configured to accommodate, in a transverse manner (i.e., in the upward direction 363 (i.e. vertical direction), shown in FIG. 3C), both the fully raised 3D printed layer 378 (shown in FIG. 3C) and the partially raised powder layer 380 (shown in FIG. 3C).

The elevated frame 352 includes a channel 354 (shown in FIG. 3C). The channel 354 has an outer flange 356 (shown in FIG. 3C), an inner flange 358 (shown in FIG. 3C), and a web 360 (shown in FIG. 3C) connecting the outer flange 356 with the inner flange 358. The web 360 extends from a base of the inner flange 358. The outer flange 356 extends transversely (i.e., in the upward direction 363) from the web 360 reaching up to the first predetermined height ΔY′. The inner flange 358 extends transversely along a top portion 362 of the first container 308, extending up to a perforated plate 364. The inner flange 358 extends along the top portion 362 such that the perforated plate 364 can be inserted therethrough.

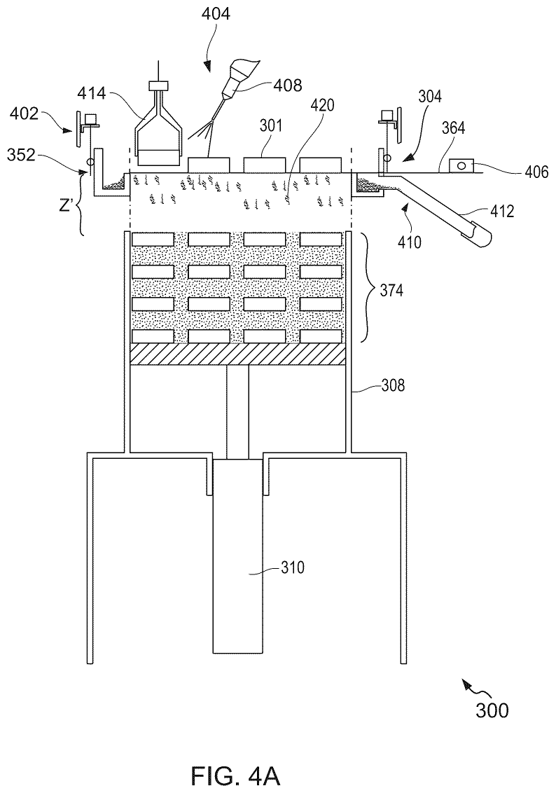

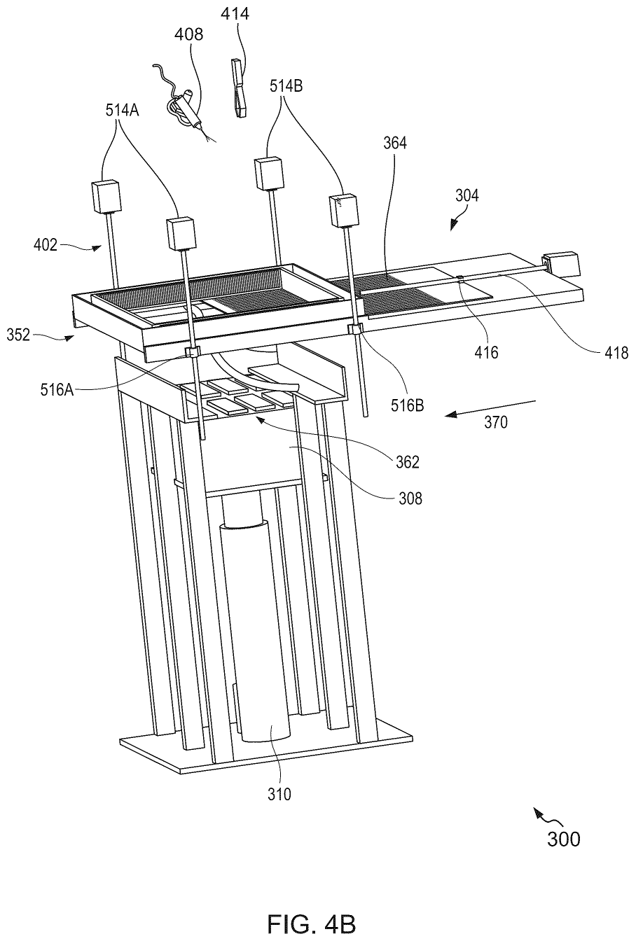

The combined presence of the outer flange 356, the inner flange 358, and the web 360 define a chamber 365 in between. The chamber 365 is configured to gather the powder through the perforated wall 367 (at the fully raised the at least one 3D printed layer 378 and the partially raised powder layer 380) around an inner circumference of the first container 308. The first container 308 is designed to gather a depowdered part 420 (as depicted in FIG. 4A) derived from the partially raised powder layer 380, alongside a depowdered part 369 (as shown in FIG. 3C) originating from the powder 382 interspersed among the one or more 3D printed parts 301.

Additionally, the elevated frame 352 further includes a perforated wall 367 (shown in FIG. 3B). The perforated wall 367 extends from the top 368 (as shown in FIG. 3C) of the inner flange 358 up to the first predetermined height ΔY′. The perforated wall 367 is configured to facilitate the flow of the depowdered powder (hereinafter “depowdered powder” is alternatively referred to as “depowdered material”) from the part 420 (as depicted in FIG. 4A) of the partially raised powder layer 380 and the depowdered material of the part 369 of the powder 382 that exist between one or more 3D printed parts 301, directing it into the chamber 365. The perforated wall 367 can be formed with one or more types of patterns that allow the depowdered material to flow into the chamber 365. For instance, as a non-limiting example, the micro-sized spherically shaped powder may flow through the perforated wall 367, which may have circular perforations. The attachment of the perforated wall 367 to the top 368 (as shown in FIG. 3C) of the inner flange 358 can be either temporary (e.g., through the use of screws, nuts, and bolts, etc.) or permanent (e.g., through welding). Furthermore, the design of the perforated wall 367 is based on considerations of bending forces and compressive forces exerted upon it.

The perforated plate 364 is slidably inserted into the elevated frame 352 and longitudinally (i.e., along a horizontal direction 370, shown in FIG. 3B)) passes through the partially raised powder layer 380. Perforated plate 364 is configured to remove at least the part of partially raised powder layer 380. In the illustrated configuration, the perforated plate 364 has a cross-section that aligns with a cross-section of the open top 366 of the first container 308. Further, the perforated plate 364 may be formed with a rigid frame around the perimeter of the perforated plate 364.

To facilitate smooth and slidable insertion of the perforated plate 364 into the elevated frame 352, a guideway 372 is disposed on an insertion side 373 (see, FIG. 3B) of the outer flange 356. It is important to note that the remaining sides of the outer flange 356, except for the insertion side 373, lack the guideway 372. This specific design allows the perforated plate 364 to be effortlessly and slidably inserted through the guideway 372 located at the insertion side 373. The guideway 372 can take the form of a slot or any other opening that permits the perforated plate 364 to be inserted into the elevated frame 352. The slot is fashioned to possess a shape that closely matches the cross-sectional shape of the perforated plate. By way of illustration, in a non-limiting example, a rectangular slot may be created on the outer flange 356 to accommodate the perforated plate 364, which itself has a rectangular shape closely resembling the cross-sectional shape of the perforated plate 364. To facilitate easy insertion, a clearance fit may be provided between the perforated plate 364 and the rectangular slot. It should be noted that the perforated plate 364 can be inserted into and withdrawn from the guideway 372 using a suitable mechanism which is activated by the controller 306.

In one embodiment, the perforated plate 364 is inserted before depowdering and extraction of the one or more printed parts 301 from a topmost layer of the plurality of extraction layers 374. Once the one or more printed parts 301 from a topmost layer of the plurality of extraction layers 374 are extracted, the perforated plate 364 is withdrawn back from the guideway 372. Then, the first linear drive actuator 310 fully raises next the at least one 3D printed layer 378 located at the top of the plurality of extraction layers 374 to the first predefined height from the open top 366 and partially raises the at least one powder layer 380 disposed below the current fully raised at least one 3D printed layer 378. At this stage, the perforated plate 364 can be inserted into and withdrawn from the guideway 372 and the process continues until all the 3D printed parts are extracted from the plurality of extraction layers 374. Thus, the depowdering and extraction of the one or more printed parts 301 are performed layer by layer in the plurality of extraction layers 374.

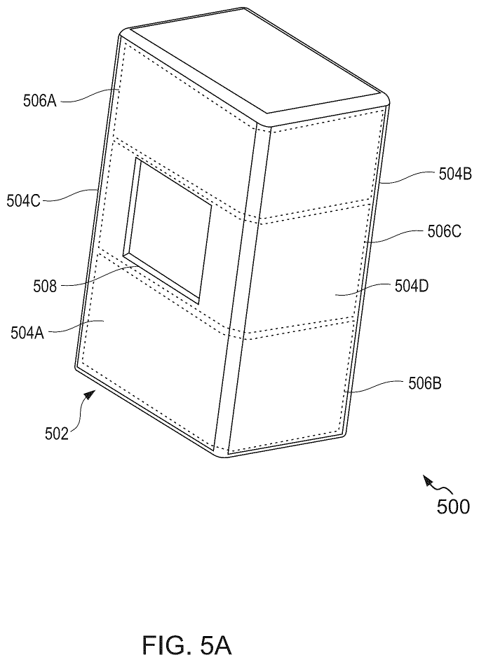

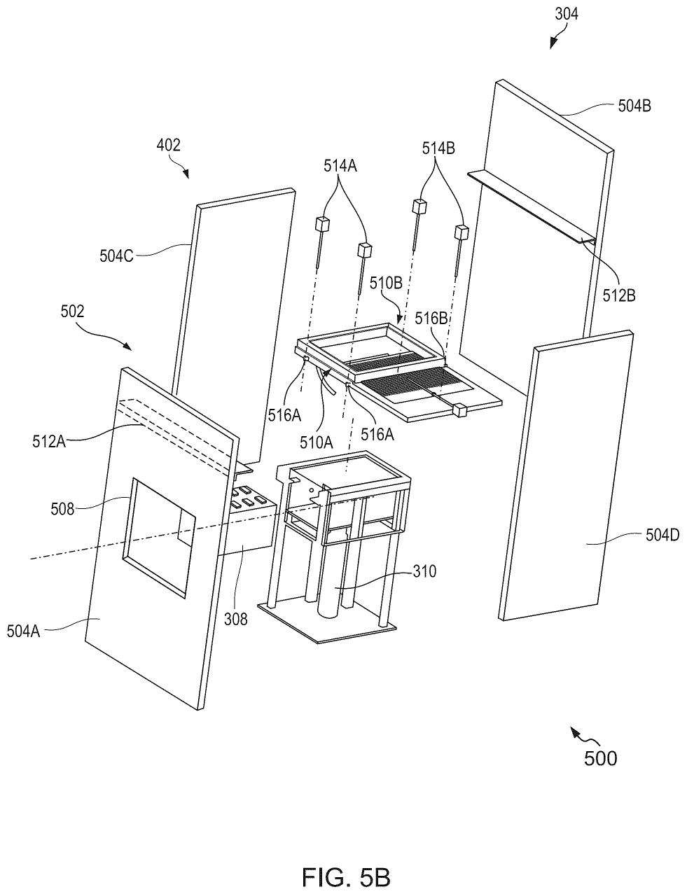

FIG. 4A illustrates a front view of the system 300 showing an apparatus 304 elevated from the first container 308, in accordance with one embodiment of the present disclosure. Additionally, FIG. 4B illustrates a perspective view of the system 300 showing the apparatus 304 raised from the first container 308, with the perforated plate 364 partially inserted into the elevated frame 352, in accordance with the same embodiment of the present disclosure. Upon the successful insertion of the perforated plate 364 into the elevated frame 352, the controller 306 transmits an input signal to a lifting-lowering mechanism 402 integrated within the apparatus 304. The lifting-lowering mechanism 402 is mechanically coupled to the elevated frame 352, and configured to lift the elevated frame 352 along with the perforated plate 364 up to a second predefined height Z′. This action occurs once the slidably insertion of the perforated plate 364 into the elevated frame 352 is accomplished. The lifting-lowering mechanism 402 includes a housing (shown in FIG. 5A) for covering the system 300. For the sake of clarity in drawings, the housing is not shown in FIGS. 3B to 4B. Detailed information concerning the geometrical configuration and the operational attributes of the lifting-lowering mechanism 402 will be elucidated with reference to FIG. 5B.

The apparatus 304 further includes a depowdering unit 404. The depowdering unit 404 is configured to remove both the powder layer 380 (see, FIG. 3C) and the powder 382 (see, FIG. 3C) that exist between one or more 3D printed parts 301 of the 3D printed layer 378 (see, FIG. 3C). The depowdering unit 404 is electronically connected to the controller 306. When the elevated frame 352, carrying the fully raised 3D printed layer 378 (as depicted in FIG. 3C) and the partially raised powder layer 380, is lifted, the controller 306 activates the depowdering unit 404.

The depowdering unit 404 includes a vibration shaker 406. The vibration shaker 406 is configured to impart vibratory motion to at least the perforated plate 364. The vibratory motion of the perforated plate 364, relative to the elevated frame 352, serves to dislodge a portion of the partially raised powder layer 380 and a portion of the powder 382 present between one or more 3D printed parts 301 of the 3D printed layer 378. The vibration shaker 406 used herein may be one of a mechanical shaker, electrodynamic shaker, hydraulic shaker, pneumatic shaker, or piezoelectric shaker. For instance, in the depicted configuration, the vibrator shaker 406 is secured to the perforated plate 364. When the perforated plate 364 is inserted into the elevated frame 352, the controller 306 activates the vibrator shaker 406 to impart vibratory motion to the perforated plate 364. Consequently, this action helps diminish the adhesive force of the powder, facilitating its removal.

In certain embodiments, to ensure that no residual powder remains adhered to the one or more 3D printed parts 301, the depowdering unit 404 additionally includes at least one pressure generator 408 (also referred to as “pressure generator 408”). The pressure generator 408 is configured to remove the powder adhered to the one or more 3D printed parts 301. The pressure generator 408 used in the illustrated embodiment may include one or more components such as a storage tank (not shown) for storing the pressurized gas (e.g., air), a convergent nozzle (not shown), and a hose (not shown) connecting the convergent nozzle with the storage tank. The pressure generator 408 is electronically connected to the controller 306. The controller 306 can regulate the gas pressure applied to the one or more printed parts 301 as needed to effectuate the depowdering process. The gas pressure exerted on the one or more printed parts 301 serves to dislodge the powder adhered to them. The depowdered material resulting from this process is then collected in the first container 308 through the perforated plate 364.

It should be noted that the powder 420 depowdered using the perforated plate 364 and the vibration shaker 406 of the depowdering unit 404 are collected into the first container 308 through the perforated plate 364. More specifically, the powder 420 of the partially raised powder layer 380, and the depowdered material from the part 369 of the powder 382 situated between one or more 3D printed parts 301, are collected into the chamber 365 through the perforated wall 367. Specifically, this pertains to the powder situated at the first predefined height ΔY′, located at the ends of the first container 308, which undergoes depowdering and is subsequently gathered within the chamber 365.

The apparatus 304 further includes a suction mechanism 410 configured to extract the depowdered material collected in the chamber 365 of the channel 354. The suction mechanism 410 includes at least a suction pipe 412 and a suction pump (not shown). One end of the at least one suction pipe 412 is connected to the web 360 of the channel 354, while the other end is connected to the suction pump. This arrangement establishes a fluidic connection between the suction pump and the chamber 365, where the depowdered material is stored. A vacuum pressure (i.e., a negative pressure with reference to the atmospheric pressure) generated by the suction mechanism 410 may be set by the controller 306, based on the amount of depowder material collected at the chamber 365. It should be noted that the suction pump of the suction mechanism 410 may further transport the collected depowdered material to a storage container. The depowdered material in the storage container can be reused for printing the 3D parts.

To facilitate the extraction of the depowdered one or more 3D printed parts 301, the apparatus 304 is equipped with at least one gripper 414 (also referred to as “gripper 414”). The primary role of this gripper 414 is to effectively extract the one or more 3D printed parts 301 from the fully raised 3D printed layer 378. In one embodiment, the system 300 may also facilitate a robotic mechanism (not shown in FIGS. 4A and 4B) including a plurality of the grippers for simultaneously handling of the one or more 3D printed parts 301. This configuration offers the advantage of depowdering by the pressure generator 408 from each side of the one or more 3D printed parts 301. Subsequently, the multiple grippers can transport the one or more 3D printed parts 301 to a suitable conveyance device, such as a conveyor, thereby streamlining the post-processing operations.

The one or more 3D printed parts 301, as depicted in the illustrated embodiment, possess a cuboid shape, specifically a rectangular cross-section. In case the 3D printer fabricates intricate and asymmetric parts, consequently, the geometrical configuration of the at least one gripper 414 would be adapted to accommodate such variations in part shapes. Furthermore, the gripper 414 may incorporate one or more sensors, which are electronically linked to the controller 306. These sensors can encompass various types, such as motion sensors, touch sensors, etc. Through the utilization of these sensors, the gripper 414 can ascertain both the shape and the precise location of the one or more 3D printed parts 301. This information allows the gripper 414 to engage with the one or more 3D printed parts 301 with a controlled and calibrated force, tailored to the specific requirements dictated by the identified shape and positioning of the parts.

Further, referring to FIG. 4B, the perforated plate 364 includes at least one movable member 416 (hereinafter referred to as “movable member 416”). The movable member 416 is configured to slide along the horizontal direction 370 about at least one stationary member 418 (hereinafter referred to as “stationary member 418”) of the elevated frame 352. The movable member 416 is shaped to be complementary to the configuration of the stationary member 418. A clearance fit is established between the movable member 416 and the stationary member 418, ensuring smooth movement. The movable member 416 may be electronically connected to the controller 306. This linkage enables the controller 306 to exercise control over the insertion and removal of the perforated plate 364 into the elevated frame 352.

The engagement of the elevated frame 352 with the open top 366 within the top portion 362 of the first container 308 can be accomplished through various means. One example employs a snap-fit arrangement, where the inner flange 358 is removably secured to the open top 366 (shown in FIG. 3B) within the top portion 362 of the first container 308 using this snap-fit configuration. Alternatively, another approach involves the use of one or more engaging members on the inner flange 358 (shown in FIG. 3C), which are designed to be removably secured to corresponding complementary engaging members located on the open top 366 of the first container 308. These engagement mechanisms ensure a secure and reliable connection between the elevated frame 352 and the first container 308, promoting the stability of the assembly.

FIG. 5A depicts an illustrative representation of an alternative embodiment of the system 500, while FIG. 5B provides an exploded view of this system 500, of the same embodiment of the present disclosure. The system 500 shares some common components with the earlier described system 300, including the apparatus 304, the first container 308, the first linear drive actuator 310, and the controller 306. In this particular embodiment, the first container 308 can be temporarily mounted to the first linear drive actuator 310. After the completion of the depowdering and extraction process, wherein the apparatus 304 retrieves the one or more 3D printed parts 301 from the first container 308, the first container 308 can be easily disengaged from the system 500. The system 500, designed for automated depowdering and extraction of the one or more 3D printed parts 301, includes the apparatus 304, the first container 308, and the first linear drive actuator 310. Importantly, the first container 308, which accommodates the plurality of extraction layers 374 (shown in FIG. 4A), can be temporarily mounted to the first linear drive actuator 310. This design feature allows for versatility, as the first container 308 from any type of 3D printer (such as SLS, DMLS, FDM, DLP, MJF, EBM, and similar technologies) can be employed, enabling the temporary mounting for the specific purposes of depowdering and extracting.

The lifting-lowering mechanism 402 (not shown in FIG. 5A) has a housing 502. The housing 502 encompasses a first sidewall 504A, a second sidewall 504B located opposite the first sidewall 504A, a third sidewall 504C, and a fourth sidewall 504D located opposite the third sidewall 504C. This arrangement ensures comprehensive coverage for both the lifting-lowering mechanism 402 and the contained first linear drive actuator 310. More specifically, at least one or more components of the lifting-lowering mechanism 402 are disposed of in a top portion 506A of the housing 502 and the first linear drive actuator 310 is disposed of in a bottom portion 506B of the housing 502, whereas, a middle portion 506C of the housing 502 has an opening 508 at least on one side of the housing 502. In the illustrated configuration, the opening 508 is formed on the first sidewall 540A. The opening 508 is adapted to encapsulate the first container 308. The housing 502 is designed in a manner that the first container 308 of any of the 3D printer can be encapsulated in the middle portion 506C of the housing 502.

As shown in FIG. 5B, the first sidewall 504A of the housing 502 is located on a first side 510A of the elevated frame 352 and the second sidewall 504B of the housing 502 is located on a second side 510B of the elevated frame 352. The first sidewall 504A secures a first bracket 512A and the second sidewall 504B secures a second bracket 512B. The first bracket 512A is configured to secure a first pair of fixed sleeves 514A and the second bracket 512B is configured to secure a second pair of fixed sleeves 514B. The first pair of fixed sleeves 514A slidably engage with a first pair of motional sleeves 516A of the first side 510A and the second pair of fixed sleeves 514B slidably engage with a second pair of motional sleeves 516B of the second side 510B.

In an embodiment, the apparatus 304 of the system 500 can be mounted to a casting unit facilitated with the first container 308. For example, in an investment casting unit, the apparatus 304 can be mounted to a printing box of the investment casting unit for depowdering and extracting casted components.

It should be noted that the plurality of extraction layers 374 includes at least one 3D printed layer 378 and at least one powder layer 380. The 3D printed layer 378 and the powder layer 380 are alternatively arranged to form the plurality of extraction layers 374. The 3D printed layer 378 consists of one or more 3D printed parts 301, with powder 382 interspersed among the one or more 3D printed parts 301. In a preprocessing step of fabrication of one or more 3D printed parts 301, a Computer-Aided Design (CAD) model is input with details, not limited to a predefined number of extraction layers 374 to be formed, a predefined height of powder layers 380 in which the one or more 3D printed parts 301 are to be formed, a predefined height of the powder layer between each of the 3D printed layers 378. The 3D printing process is performed using the 3D printer based on the preset input provided to the CAD model. In one embodiment of the invention, the CAD model can act as the controller 306 and automatically controls one or more operations of the system for depowdering and extraction of the 3D printed parts 301. In one embodiment of the invention, the controller 306 retrieves the information from the CAD model and automatically performs one or more control operations of the system for depowdering and extraction of the 3D printed parts 301. The one or more control operations of the system are not limited to a) lifting the first container 308 with the plurality of extraction layers 374 using the first linear drive actuator 310 to the first predetermined height; b) lowering and securing the elevated frame 352 to the open top 366 using the lifting-lowering mechanism 402; c) inserting the perforated plate 364 through the guideway 372; d) raising the elevated frame 352 with the perforated plate 364 using the lifting-lowering mechanism 402; and e) performing depowdering operation and extracting the 3D printed parts 301, using the depowdering unit 404.

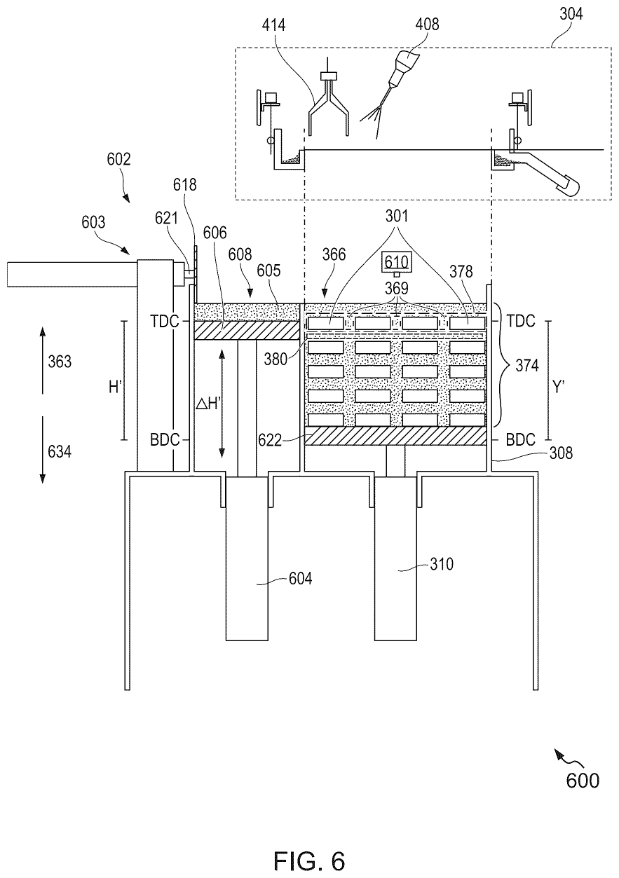

FIG. 6 illustrates a perspective view of a system 600 related to printing, depowdering, and extracting three-dimensional (3D) printed parts, in accordance with an alternate embodiment of the present disclosure. In a preferred embodiment, the system 300 performs only depowering and extracting the 3D printed parts, whereas the printing of the 3D printed parts is performed with the help of conventional 3D printers. In the alternative embodiment as shown in FIG.6, the system along with the depowering and extracting of the 3D printed parts, printing of the 3D printed parts is also performed. In such scenarios, any of the conventional print box of a 3D printer 602 will act as the first container 308. The first container 308 of the 3D printer 602 can be used as the first container 308 for depowering and extracting the printed parts. Thus, the printing, depowdering, and extraction of the printed parts can be performed in using the single system 600.

In the case of the printing process and the depowdering, and extraction process of the printed parts 301 are performed separately, the first container 308 with the printed extraction layers 374 can be used in the system 300 (shown in FIG. 3C) can be used, for the depowdering, and extracting of the printed parts. In such a scenario, the print box after printing the parts using the conventional 3D printer can be used as the first container 308. Thus, the system of the present invention is not limited to only to depowdering, and extraction of parts printed by a separate 3D printer, but also performs various operations including the process of the 3D printer, thus a single system 600 can be used for printing, and automatic depowdering and extraction of the printed parts.

As shown in FIG. 6, the system 600 has the 3D printer 602 that includes the first container 308, a second container 603, a first linear drive actuator 310, and a second linear drive actuator 604. The second container 603 is designed for the containment of powder 605 and incorporates a movable tray 606 and an open head 608. The powder 605 stored within the second container 603 is initially transported to the first container 308 and subsequently subjected to processing, which involves heating and hardening the powders, utilizing a binder jetting device 610 integrated within the 3D printer 602. A Selective Laser Sintering (SLS) 3D printer is used for present description for example purposes only, and the system may be implemented using any other 3D printers such as Direct Metal Laser Sintering (DMLS), Fused Deposition Modeling (FDM), Digital Light Process (DLP), Multi-Jet Fusion (MJF), Electronic Beam Melting (EBM), and the like that uses the first container.

When the powder 605 is filled in the second container 603, the movable tray 606 is at a Bottom Dead Center (BDC) of the second container 603. In case, the second container 603 is empty with no powder in it, the movable tray 606 is at a Top Dead Center (TDC). In between BDC and TDC, the movable tray 606 reciprocates in a downward reciprocating direction 634 and upward direction 363 by distance H′. The movable tray 606 is operated by the second linear drive actuator 604. The second linear drive actuator 604 is electronically connected to the controller 306 (shown in FIG. 3A) and reciprocally coupled to the movable tray 606 to raise a part of the powder 605 above the open head 608 by a third predetermined height (e.g. ΔH′) of the height H′. The third predetermined height ΔH′ provided by the second linear drive actuator 604 is controlled by the controller 306. When the movable tray 606 reciprocates transversely in the upward direction 363 by the third predefined height ΔH′, the powder 605 stored in the second container 603 will also reciprocate in the upward direction 363 by the third predefined height ΔH′ above the open head 608.

The second linear drive actuator 604 may take the form of a hydraulic linear actuator, a pneumatic linear actuator, an electric linear actuator, or a piezoelectric actuator. The second linear drive actuator 604 shown in the illustrated example embodiment is the hydraulic linear actuator. This hydraulic linear actuator is designed to transform the energy stored within the working fluid into mechanical work, primarily facilitating the reciprocating motion of the movable tray 606. The working fluid's pressure acts upon a piston within the hydraulic linear actuator, generating a propulsive force that induces the upward reciprocating movement of the movable tray 606 along the upward direction 363. As the second linear drive actuator 604 maintains an electronic connection with the controller 306, adjustments to the third predetermined height ΔH′ can be made as necessary.

A pusher device 614 within the 3D printer 602 is electrically connected to the controller 306 and designed to transfer the portion of the powder 605 corresponding to the third predetermined height ΔH′ (i.e., the powder situated above the open head 608) to the open top 366 of the first container 308. This pusher device 614 incorporates a powder spreader 618. The powder spreader 618 is configured to level the powder positioned at the open top 366, resulting in the formation of a sublayer. In the present illustrated embodiment, the powder spreader 618 takes the shape of a square plate, which is reciprocated by a movable bar 621 within the pusher device 614. However, in an alternative configuration, a cylindrical powder spreader may be utilized.

The first container 308 is designed to accommodate a plurality of extraction layers 374 longitudinally, extending from the movable base 622 to the open top 366. The plurality of extraction layers 374 includes the 3D printed layer 378 and the powder layer 380. These layers, namely the 3D printed layer 378 and the powder layer 380, are alternatively arranged. The 3D printed layer 378 consists of one or more 3D printed parts 301, with powder 382 interspersed among the one or more 3D printed parts 301. In the illustrated example embodiment, the one or more 3D printed parts 301 have cuboidal shapes. However, in other embodiments, more intricate and non-symmetrical shapes can also be prepared.

During the initiation of the printing process, the movable base 622 is at a Top Dead Center (TDC) of the first container 308 (i.e., at the open top 366). As the first container 308 becomes filled with the plurality of extraction layers 374, the movable base 622 commences a downward reciprocating motion 634 by a distance denoted as Y′ until it reaches the Bottom Dead Center (BDC) of the first container 308. Conversely, for the purpose of depowdering and extracting the one or more 3D printed parts 301, executed by the apparatus 304, the movable base 622 executes an upward motion 363 (reciprocating), moving from the BDC of the first container 308 towards the TDC of the first container 308.

The movable base 622 is actuated by the first linear drive actuator 310. The first linear drive actuator 310 is electronically connected to the controller 306 and reciprocally coupled to the movable base 622 to elevate the 3D printed layer 378 located at the uppermost part of the plurality of extraction layers 374, raising it to a first predetermined height ΔY′ of the height Y′ from the open top 366. Additionally, the first linear drive actuator 310 partially raises the powder layer 380 disposed beneath the fully raised 3D printed layer 378.

The first linear drive actuator 310 may take the form of a hydraulic linear actuator, a pneumatic linear actuator, an electric linear actuator, or a piezoelectric actuator. In the illustrated example embodiment, the first linear drive actuator 310 is specifically represented as a hydraulic linear actuator. The hydraulic linear actuator is configured to convert the energy stored within the working fluid contained within the hydraulic linear actuator into mechanical work, thereby facilitating the reciprocating motion of the movable base 622. The pressure of the working fluid acts on a piston of the hydraulic linear actuator, generating a pushing force that induces the upward reciprocating movement of the movable base 622 along the upward direction 363. As the first linear drive actuator 310 is electronically connected to the controller 306, the first predetermined height ΔY′ can be adjusted as necessary.

It may be noted that the 3D printer 602 is shown to have included the above-stated parts, however, those skilled in the art would appreciate that the 3D printer 602 includes other parts which may not be relevant for elucidating the present disclosure and hence are not shown and described.

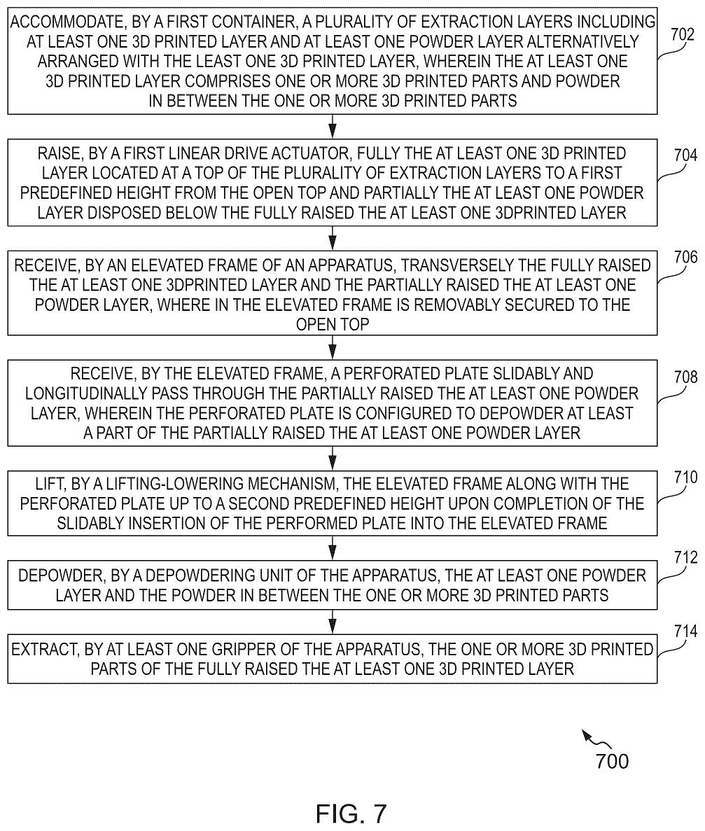

FIG. 7 illustrates a flow diagram illustrating a method 700 for providing interactive adult entertainment, in accordance with an embodiment of the present disclosure. It should be noted that the sequence of the method 700 may not be necessarily executed in the same order as they are presented. Further, one or more steps may be grouped and performed in the form of a single step, or one step may have several sub-steps that may be performed in a parallel or a sequential manner. The method 700 begins at Step 702.

At Step 702, the first container 308 accommodates the plurality of extraction layers 374. The plurality of extraction layers 374 includes the at least one 3D printed layer 378 and the at least one powder layer 380. The at least one 3D printed layer 378 and the at least one powder layer 380 are alternatively arranged with each other in the plurality of extraction layers 374. The at least one 3D printed layer 378 includes one or more 3D printed parts 301 and the powder 382 in between one or more 3D printed parts 301. The geometrical configuration and operating features of the first container 308 accommodating the plurality of extraction layers 374 are already explained with respect to FIG. 4A, and therefore, not reiterated here for the sake of brevity.

At Step 704, the first linear drive actuator 310 fully raises the at least one 3D printed layer 378 located at the top of the plurality of extraction layers 374 to the first predefined height ΔY′ from the open top 366 and partially raises the at least one powder layer 380 disposed below the fully raised at least one 3D printed layer 378.

At Step 706, the elevated frame 352 transversely receives the fully raised at least one 3D printed layer 378 and the partially raised at least one powder layer 380. It should be noted that the elevated frame 352 is removably secured to the open top 366.

At Step 708, the method 700 includes the elevated frame 352 receiving a perforated plate 364 that is slidably inserted longitudinally through the partially raised at least one powder layer 380, where the perforated plate 364 is designed to depowder by removing at least a portion of the partially raised at least one powder layer 380.

At Step 710, the lifting-lowering mechanism 402 lifts the elevated frame 352 along with the perforated plate 364 up to the second predefined height Z′, upon completion of the slidably insertion of the performed plate 364 into the elevated frame 352. The geometrical configuration and operating features of the lifting-lowering mechanism 402 are already discussed in detail with respect to FIG. 5B, and therefore, not reiterated here for the sake of brevity.

At Step 712, the depowdering unit 404 including the vibration shaker 406 and the at least one pressure generator 408 removes the at least one powder layer 380 and the powder 382 in between one or more 3D printed parts 301.

At Step 714, the least one gripper 414 extracts the one or more 3D printed parts 301 of the fully raised at least one 3D printed layer 378. At this step, the perforated plate 364 that is slidably inserted into the elevated frame can be withdrawn back from the guideway 372 and the Steps 704, 706, 708, 710, 712, and 714 are repeated until all the 3D printed parts are extracted from each of the plurality of extraction layers 374. After the withdrawal of the perforated plate 364, the first linear drive actuator 310 fully raises the current topmost the at least one 3D printed layer 378 and partially raises the partially raised at least one powder layer 380 below the current topmost the at least one 3D printed layer 378. When all the 3D printed parts are extracted, a sintering process is performed where the parts are placed into the furnace to get the desired shape of the 3D printed parts.

Various embodiments of the disclosure, as discussed above, may be practiced with steps and/or operations in a different order, and/or with hardware elements in configurations, which are different than those which are disclosed. Therefore, although the disclosure has been described based on these exemplary embodiments, it is noted that certain modifications, variations, and alternative constructions may be apparent and well within the scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A system comprising:
a controller;
a first container comprising a movable base and an open top, the first container configured to longitudinally accommodate a plurality of extraction layers comprising at least one 3D printed layer and at least one powder layer alternatively arranged with the least one 3D printed layer, wherein the at least one 3D printed layer comprises one or more 3D printed parts and powder positioned between the one or more 3D printed parts;
a first linear drive actuator electronically connected to the controller and reciprocally coupled to the movable base to fully raise the at least one 3D printed layer located at a top of the plurality of extraction layers up to a first predetermined height from the open top and to partially raise the at least one powder layer disposed below the fully raised at least one 3D printed layer; and
an apparatus electronically connected to the controller and configured to depowder the at least one powder layer and the powder in between one or more 3D printed parts and to extract the one or more 3D printed parts, the apparatus comprising:
an elevated frame removably secured to the open top and configured to transversely receive at least the fully raised at least one 3D printed layer and the partially raised at least one powder layer;
a perforated plate slidably inserted into the elevated frame, capable of longitudinally passing through the partially raised at least one powder layer and depowdering at least a part of the partially raised at least one powder layer;
a lifting-lowering mechanism mechanically coupled to the elevated frame, the lifting-lowering mechanism configured to removably secure the elevated frame to the open top during the slidable insertion of the perforated plate into the elevated frame, and configured to lift the elevated frame along with the perforated plate up to a second predefined height upon completion of the slidable insertion of the performed plate into the elevated frame;
a depowdering unit electronically coupled to the controller and configured to depowder the at least one powder layer, the powder in between one or more 3D printed parts, and powder adhered to the one or more 3D printed parts; and
at least one gripper electronically coupled to the controller and configured to automatically extract the one or more 3D printed parts of the fully raised at least one 3D printed layer.

2. The system as claimed in claim 1, wherein the depowdering unit comprises:
a vibration shaker electronically connected to the controller and configured to impart vibratory motion to at least the perforated plate to depowder a part of the partially raised at least one powder layer and a part of the powder in between one or more 3D printed parts; and
at least one pressure generator electronically coupled to the controller and configured to depowder the powder adhered to the one or more 3D printed parts.

3. The system as claimed in claim 1, wherein the elevated frame comprises a channel, the channel comprises:
an inner flange raising transversely along a top portion of the first container up to the perforated plate;
a web extending outwardly from a base of the inner flange; and
an outer flange raising transversely from the web up to the first predetermined height,
wherein the inner flange, the web, and the outer flange define a chamber therebetween to receive the depowdered part of the partially raised at least one powder layer and the depowdered part of the powder in between one or more 3D printed parts.

4. The system as claimed in claim 3, wherein the elevated frame further comprises a perforated wall secured to the inner flange, the perforated wall extending upwardly from a top of the inner flange up to the first predetermined height, wherein the perforated wall is configured to flow the depowdered part of the partially raised at least one powder layer and the depowdered part of the powder in between the one or more 3D printed parts into the chamber.

5. The system as claimed in claim 3, wherein the perforated plate is slidably inserted into the elevated frame through a guideway of the outer flange and through a top of the inner flange, the guideway has a shape complementary to a cross-sectional shape of the perforated plate.

6. The system as claimed in claim 3, further comprising a suction mechanism configured to take out the depowdered part of the partially raised at least one powder layer and the depowdered part of the powder in between the one or more 3D printed parts collected in the chamber, wherein the suction mechanism comprises at least a suction pipe and a suction pump, the suction pipe fluidically connects the chamber with the suction pump.

7. The system as claimed in claim 1, wherein the first linear drive actuator is one of a hydraulic linear actuator, a pneumatic linear actuator, an electric linear actuator, or a piezoelectric actuator.

8. The system as claimed in claim 1, wherein the perforated plate comprises at least one movable member configured to slide with respect to at least one stationary member of the elevated member, the at least one movable member has a shape complementary to a shape of the at least one stationary member.

9. The system as claimed in claim 1, wherein the lifting-lowering mechanism comprises:
a housing comprising a first sidewall and a second sidewall, the first sidewall located on a first side of the elevated frame and the second sidewall located on a second side of the elevated frame;
a first bracket and a second bracket, the first bracket secured to the first sidewall and the second bracket secured to the second sidewall;
a first pair of fixed sleeves and a second pair of fixed sleeves, the first pair of fixed sleeves secured to the first bracket and the second pair of fixed sleeves secured to the second bracket; and
a first pair of motional sleeves and second pair of motional sleeves,
wherein the first pair of fixed sleeves slidably engage with the first pair of motional sleeves of the first side and the second pair of fixed sleeves slidably engages with the second pair of motional sleeves of the second side.

10. The system as claimed in claim 9, wherein the housing further comprises an opening configured to receive the first container and to provide covering to at least the first linear drive mechanism.

11. The system as claimed in claim 1, further comprising a 3D printer, the 3D printer comprising:
a second container comprising a movable tray and an open head, the second container configured to store the powder;
a second linear drive actuator electronically connected to the controller and reciprocally coupled to the movable tray to raise the powder above the open head by a third predetermined height;
a pusher device electronically connected to the controller and configured to transfer the powder of the third predetermined height located above the open head to the open top of the first container to form a powder layer on the movable base for printing the one or more 3D printed parts, wherein upon transferring the powder by the third predetermined height, the first linear drive actuator transversely lowers the movable base by the third predetermined height; and
a binder jetting device electronically connected to the controller and configured to dispense binder droplets of the binder jetting device onto a part of the powder located in the first container.

12. The system as claimed in claim 11, wherein the pusher device comprises a powder spreader configured to flatten the powder layer for printing the one or more 3D printed parts.

13. An apparatus mounted to a first container of a system and electronically connected to a controller, the apparatus comprising:
an elevated frame removably secured to an open top of the first container and configured to transversely receive at least fully raised at least one 3D printed layer and partially raised at least one powder layer, wherein the at least one 3D printed layer comprises one or more 3D printed parts and powder in between the one or more 3D printed parts;
a perforated plate slidably inserted into the elevated frame and longitudinally passing through the partially raised at least one powder layer, wherein the perforated plate is configured to depowder at least a part of the partially raised at least one powder layer;
a lifting-lowering mechanism mechanically coupled to the elevated frame, the lifting-lowering mechanism configured to removably secure the elevated frame to the open top during the slidably insertion of the perforated plate into the elevated frame and to lift the elevated frame along with the perforated plate up to a second predefined height upon completion of the slidably insertion of the performed plate into the elevated frame;
a depowdering unit electronically coupled to the controller and configured to depowder the at least one powder layer, the powder in between one or more 3D printed parts, and powder adhered to the one or more 3D printed parts; and
at least one gripper electronically coupled to the controller and configured to automatically extract the one or more 3D printed parts of the fully raised the at least one 3D printed layer.

14. The apparatus as claimed in claim 13, wherein the depowdering unit comprises:
a vibration shaker electronically connected to the controller and configured to impart vibratory motion to at least the perforated plate to depowder the part of the partially raised at least one powder layer and a part of the powder in between one or more 3D printed parts; and
at least one pressure generator electronically coupled to the controller and configured to depowder the powder adhered to the one or more 3D printed parts.

15. The apparatus as claimed in claim 13, wherein the elevated frame comprises a channel, the channel comprising:
an inner flange raising transversely along a top portion of the first container up to the perforated plate;
a web extending outwardly from a base of the inner flange; and
an outer flange raising transversely from the web up to a first predetermined height,
wherein the inner flange, the web, and the outer flange define a chamber therebetween to receive the depowdered part of the partially raised at least one powder layer and the depowdered part of the powder in between one or more 3D printed parts.

16. The apparatus as claimed in claim 15, wherein the elevated frame further comprises a perforated wall secured to the inner flange, the perforated wall extending upwardly from a top of the inner flange up to the first predetermined height, wherein the perforated wall is configured to flow the depowdered part of the partially raised at least one powder layer and the depowdered part of the powder in between the one or more 3D printed parts into the chamber.

17. The apparatus as claimed in claim 15, wherein the perforated plate is slidably inserted into the elevated frame through a guideway of the outer flange and the guideway of the inner flange, the guideway has a shape complementary to a cross-sectional shape of the perforated plate.

18. The apparatus as claimed in claim 13, further comprising a suction mechanism configured to take out the depowdered part of the partially raised at least one powder layer and the depowdered part of the powder in between the one or more 3D printed parts collected in the chamber, wherein the suction mechanism comprises at least a suction pipe and a suction pump, the suction pipe fluidically connects the chamber with the suction pump.

19. The apparatus as claimed in claim 13, wherein the lifting-lowering mechanism comprises:
a housing comprising a first sidewall and a second sidewall, the first sidewall located on a first side of the elevated frame and the second sidewall located on a second side of the elevated frame;
a first bracket and a second bracket, the first bracket secured to the first sidewall and the second bracket secured to the second sidewall; and
a first pair of fixed sleeves and a second pair of fixed sleeves, the first pair of fixed sleeves secured to the first bracket and the second pair of fixed sleeves secured to the second bracket,
wherein the first pair of fixed sleeves slidably engage with a first pair of motional sleeves of the first side and the second pair of fixed sleeves slidably engages with a second pair of motional sleeves of the second side.

20. The apparatus as claimed in claim 19, wherein the housing further comprises an opening configured to receive the first container and to provide covering to at least the first linear drive actuator.

21. A method comprising:
accommodating, by a first container, a plurality of extraction layers comprising at least one three-dimensional (3D) printed layer and at least one powder layer alternatively arranged with the least one 3D printed layer, wherein the at least one 3D printed layer comprises one or more 3D printed parts and powder in between the one or more 3D printed parts;
raising, by a first linear drive actuator, fully the at least one 3D printed layer located at a top of the plurality of extraction layers to a first predefined height from the open top and partially the at least one powder layer disposed below the fully raised at least one 3D printed layer;
receiving, by an elevated frame of an apparatus, transversely the fully raised at least one 3D printed layer and the partially raised at least one powder layer, wherein the elevated frame is removably secured to the open top;
receiving, by the elevated frame, a perforated plate slidably and longitudinally pass through the partially raised at least one powder layer, wherein the perforated plate is configured to depowder at least a part of the partially raised at least one powder layer;
lifting, by a lifting-lowering mechanism of the apparatus, the elevated frame along with the perforated plate up to a second predefined height upon completion of the slidably insertion of the performed plate into the elevated frame;
depowdering, by a depowdering unit of the apparatus, the at least one powder layer, the powder in between one or more 3D printed parts, and powder adhered to the one or more 3D printed parts; and
extracting, by at least one gripper of the apparatus, the one or more 3D printed parts of the fully raised at least one 3D printed layer.

22. The method as claimed in claim 21, further comprising:
providing, by a vibration shaker, vibratory motion to at least the perforated plate to depowder a part of the partially raised at least one powder layer and a part of the powder in between one or more 3D printed parts; and
depowdering, by at least one pressure generator, the powder adhered to the one or more 3D printed parts.

23. The method as claimed in claim 21, wherein the elevated frame comprises a channel, the channel comprising:
an inner flange raising transversely along a top portion of the first container up to the perforated plate;
a web extending outwardly from a base of the inner flange; and
an outer flange raising transversely from the web up to a first predetermined height; and
wherein the inner flange, the web, and the outer flange define a chamber therebetween to receive the depowdered part of the partially raised at least one powder layer and the depowdered part of the powder in between one or more 3D printed parts.

24. The method as claimed in claim 23, further comprising allowing, by a perforated wall, the depowdered part of the partially raised at least one powder layer and the depowdered part of the powder in between the one or more 3D printed parts into the chamber.

25. The method as claimed in claim 21, wherein the lifting-lowering mechanism comprises:
a housing comprising a first sidewall and a second sidewall, the first sidewall located on a first side of the elevated frame and the second sidewall located on a second side of the elevated frame;
a first bracket and a second bracket, the first bracket secured to the first sidewall and the second bracket secured to the second sidewall; and
a first pair of fixed sleeves and a second pair of fixed sleeves, the first pair of fixed sleeves secured to the first bracket and the second pair of fixed sleeves secured to the second bracket,
wherein the first pair of fixed sleeves slidably engage with a first pair of motional sleeves of the first side and the second pair of fixed sleeves slidably engages with a second pair of motional sleeves of the second side.
